(19) United States
(12) Patent Application Publication
(10) Pub. No.: US 2024/0331668 A1
(43) Pub. Date: Oct. 3, 2024

(54) ELECTRONIC INSTRUMENT, AUTOMATIC OPERATION METHOD, AND NON-TRANSITORY COMPUTER READABLE MEDIUM

(71) Applicant: Roland Corporation, Shizuoka (JP)

(72) Inventor: Ryo Susami, Hamamatsu (JP)

(73) Assignee: Roland Corporation, Shizuoka (JP)

(21) Appl. No.: 18/605,857

(22) Filed: Mar. 15, 2024

(30) Foreign Application Priority Data
Mar. 31, 2023 (JP) 2023-058971

(51) Int. Cl. G10H 1/34

(52) U.S. Cl. CPC G10H 1/34; G10H 2230/035

(57) ABSTRACT

By controlling key-pressing/key-releasing of keys 2a so a pressed key quantity Np is equal to or less than a maximum pressed key quantity Mp less than a maximum control quantity, the quantity of keys 2a capable of being released among the maximum control quantity Mc can be secured. Accordingly, key-releasing control of keys 2a during key-releasing can continue even when key-pressing is instructed for most keys 2a. Thus, the discomfort of listeners for key-releasing can be reduced. In addition, with keys 2a on which only key-releasing that consumes less power than key-pressing is performed being secured among the keys 2a of the maximum control quantity Mc, the power consumption required by the keyboard 2 during automatic operation is reduced, and the power capacity of an electronic piano 1 can be reduced. Accordingly, the increase in cost with respect to the power source of the electronic piano 1 can be suppressed.

### CROSS-REFERENCE TO RELATED APPLICATION

This application claims the priority benefit of Japan application no. 2023-058971, filed on Mar. 31, 2023. The entirety of the above-mentioned patent application is hereby incorporated by reference herein and made a part of this specification.

### BACKGROUND

### Technical Field

The invention relates to an electronic instrument, an automatic operation method, and a non-transitory computer readable medium.

### Description of Related Art

Patent Document 1 discloses an electronic instrument, in which key-on data and key-off data are obtained from song data stored in an external storage device 81, musical sounds are generated and output by a sound source circuit 66 and a sound system 69 by using the obtained key-on data and key-off data, and keys 11 are pressed or released through driving of solenoids 52. The solenoid 52 is driven when the key 11 is released, and the speed at which the key 11 is released can thus be slower than the speed based on gravity. Therefore, the impact at the time of returning to the original position before the key 11 is pressed can be alleviated, and the mechanical noise at the time when the key 11 returns to the original position can be suppressed from occurring.

### PRIOR ART DOCUMENT(S)

### Patent Document(s)

[Patent Document 1] Japanese Laid-open No. 2008-233828

However, in the electronic instrument of Patent Document 1, the maximum control quantity, which is the quantity of keys that can be pressed or released at the same time, is limited to 10 based on the capacity of the power source mounted therein. In the state in which the key-pressing at a key 11 ends and key-release control has just started, if ten new pressing instructions of the keys 11 are added, the quantity of keys 11 that are pressed or released exceeds the maximum control quantity of 10. In such case, to suppress the discrepancy between the output musical sound and the operation of the key 11, the pressing of the key 11 is prioritized. Therefore, the release control for the key 11 whose release control has just started is stopped. Accordingly, the speed of the key 11 that has been pressed until just before and has just started to be released changes from the state of being suppressed by the driving force of the solenoid 52 to the speed based on gravity. Due to the impact at the time when the key 11 returns to the original position, the mechanical noise occurs, and the listener may feel uncomfortable. Meanwhile, in order to increase the maximum control quantity so as to increase the quantity of keys 11 that can be pressed or released at the same time, it is necessary to mount a power source with a large capacity in the electronic apparatus, and the cost for the power source of the electronic apparatus may increase.

The invention provides an electronic instrument, an automatic operation method, and a non-transitory computer readable medium capable of reducing the listener's discomfort with respect to key-releasing of the key even in the case where multiple keys are automatically operated at the same time while suppressing the increase of cost for the power source.

### SUMMARY

In order to achieve the objective, an aspect of the invention provides an electronic instrument. The electronic instrument includes a keyboard having keys capable of automatic operation. The electronic instrument includes: a pressed key quantity obtaining part, obtaining a pressed key quantity that is a quantity of keys pressed in the automatic operation; a maximum pressed key quantity obtaining part, obtaining a maximum pressed key quantity that is a quantity less than a maximum control quantity, which is a maximum quantity that key-pressing and key-releasing of keys are able to be performed at a same time in the automatic operation, and is a maximum quantity of keys where key-pressing is able to be performed in the automatic operation; and a control switching part, in a case where a key-pressing instruction for a key is newly obtained in the automatic operation and the pressed key quantity obtained by the pressed key quantity obtaining part is equal to or greater than the maximum pressed key quantity obtained by the maximum pressed key quantity obtaining part, giving a key-releasing instruction to one of keys pressed in the automatic operation and starting key-pressing of the key obtaining the key-pressing instruction.

Another aspect of the invention provides an automatic operation method executed by an electronic instrument including a keyboard having keys capable of automatic operation. The automatic operation method includes: a pressed key quantity obtaining step of obtaining a pressed key quantity that is a quantity of keys pressed in the automatic operation; a maximum pressed key quantity obtaining step, obtaining a maximum pressed key quantity that is a quantity less than a maximum control quantity, which is a maximum quantity that key-pressing and key-releasing of keys are able to be performed at a same time in the automatic operation, and is a maximum quantity of keys where key-pressing is able to be performed in the automatic operation; and a control switching step, in a case where a key-pressing instruction for a key is newly obtained in the automatic operation and the pressed key quantity obtained in the pressed key quantity obtaining step is equal to or greater than the maximum pressed key quantity obtained in the maximum pressed key quantity obtaining step, giving a key-releasing instruction to one of keys pressed in the automatic operation and starting key-pressing of the key obtaining the key-pressing instruction.

Yet another aspect of the invention provides a non-transitory computer readable medium storing an automatic operation program. The automatic operation program causes a computer including a keyboard having keys capable of automatic operation to execute an automatic operation process for the keys of the keyboard. The automatic operation program includes: a pressed key quantity obtaining step of obtaining a pressed key quantity that is a quantity of keys pressed in the automatic operation; a maximum pressed key quantity obtaining step, obtaining a maximum pressed key quantity that is a quantity less than a maximum control quantity, which is a maximum quantity that key-pressing and key-releasing of keys are able to be performed at a same time in the automatic operation, and is a maximum quantity of keys where key-pressing is able to be performed in the automatic operation; and a control switching step, in a case where a key-pressing instruction for a key is newly obtained in the automatic operation and the pressed key quantity obtained in the pressed key quantity obtaining step is equal to or greater than the maximum pressed key quantity obtained in the maximum pressed key quantity obtaining step, giving a key-releasing instruction to one of keys pressed in the automatic operation and starting key-pressing of the key obtaining the key-pressing instruction.

### BRIEF DESCRIPTION OF THE DRAWINGS

FIG. 1 is a view illustrating the appearance of an electronic piano.

FIG. 2A is a is a schematic diagram illustrating key-pressing and key-releasing state and the maximum control quantity as well as the maximum pressed key quantity. FIG. 2B is a diagram illustrating a case where the pressed key quantity is the maximum pressed key quantity. FIG. 2C is a diagram illustrating a case where the pressed key quantity is smaller than the maximum pressed key quantity.

FIG. 3A is a diagram illustrating a virtual envelope. FIG. 3B is a diagram illustrating a process of determining a target key using the virtual envelope.

FIG. 4 is a functional block diagram of the electronic piano.

FIG. 5 is a block diagram illustrating an electrical configuration of the electronic piano.

FIG. 6 is a schematic diagram illustrating a resource table.

FIG. 7A is a flowchart of a key-pressing request process, and FIG. 7B is a flowchart of a key-releasing request process.

FIG. 8 is a flowchart illustrating a pressed key quantity limitation process.

FIG. 9 is a flowchart illustrating a key-pressing resource selection process.

FIG. 10 is a flowchart illustrating a timer 0% interruption process.

FIG. 11A is a flowchart illustrating a timer 10% interruption process, and FIG. 11B is a flowchart illustrating a timer 80% interruption process.

### DESCRIPTION OF THE EMBODIMENTS

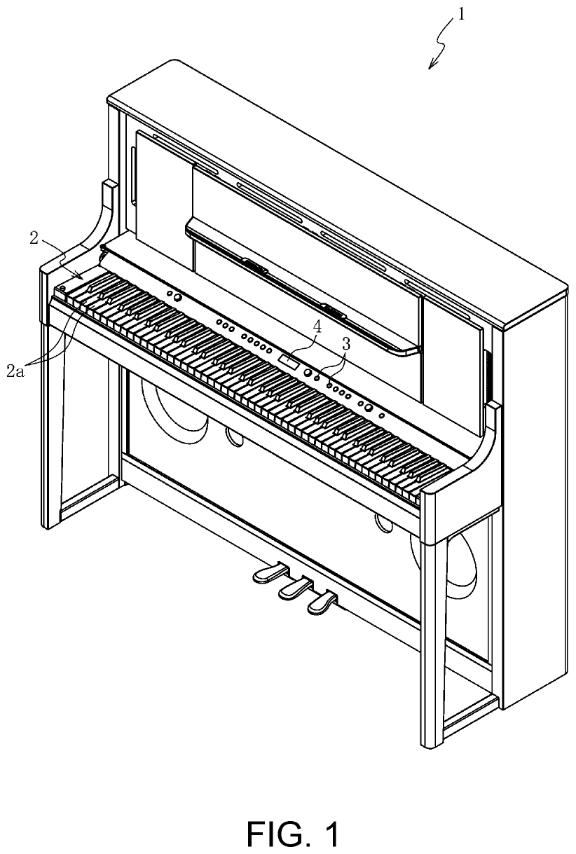

In the following, the exemplary embodiments are described with reference to the accompanying drawings. Firstly, an electronic piano 1 according to the embodiment is described with reference to FIG. 1. FIG. 1 is a view illustrating the appearance of the electronic piano 1. The electronic piano 1 is an electronic instrument that produces musical sounds based on the performance of a user H and musical sounds based on MIDI data, which are musical data under the standard of musical instrument digital interface (MIDI).

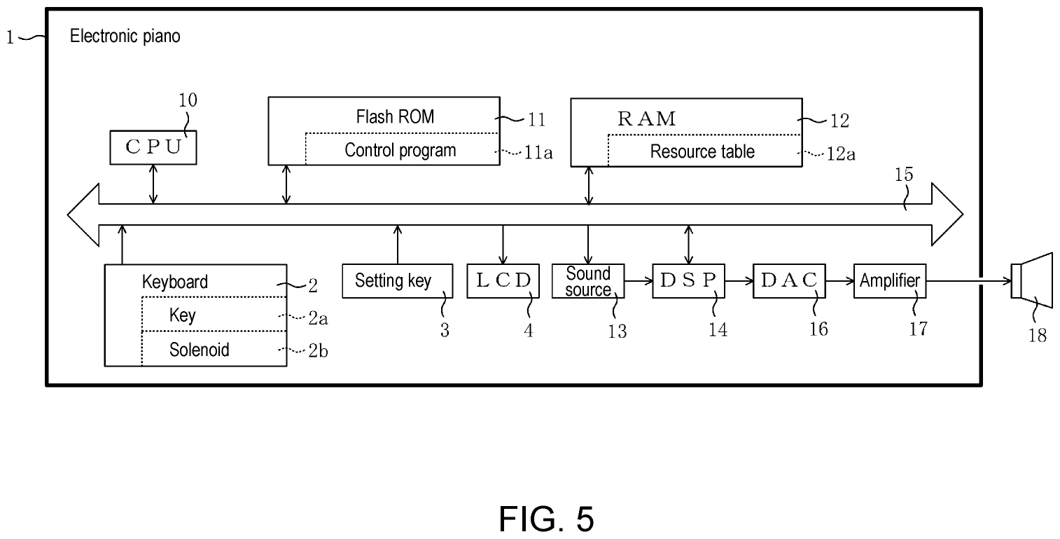

The electronic piano 1 is provided with a keyboard 2, a setting key 3, and an LCD 4. Various settings from the user H are input with the setting key 3, and the setting states of various settings are displayed on the LCD 4. The keyboard 2 is an input device for obtaining the performance information according to the performance of the user H. Multiple keys 2a are arranged on the keyboard 2, and the performance information under the MIDI standard in accordance with key-pressing/key-releasing operations of the keys 2a performed by the user H is output to the CPU 10 (see FIG. 5) and output as musical sounds.

The keyboard 2 is further provided with solenoids 2b that respectively and independently drive the keys 2a in an upper-lower direction. Key-pressing of the key 2a is realized by driving the key 2a downward through the solenoid 2b in the case where note-on in the performance information is obtained from the MIDI data designated by the user H. Meanwhile, in the case where note-off in the performance information is obtained from the MIDI data, the releasing of the key 2a is realized by driving the key 2a upward by using the solenoid 2b.

More specifically, the solenoid 2b is driven through pulse width modulation (PWM) control. In the embodiment, in the case where the key 2a is pressed, a High output (referred to as “H output” in the following) is performed on the solenoid 2b during the period of 80% of a predetermined cycle (e.g., 1 millisecond), and the key 2a is thus moved downward.

Meanwhile, in the case of releasing the key 2a, the H output is performed on the solenoid 2b during a period of 10% of the predetermined cycle. Through the driving force of the solenoid 2b, the key 2a that is pressed and moved downward becomes a resistance force of the key 2a that moves drastically upward due to the effect of gravity. Accordingly, since the movement of the key 2a during key-releasing is slow, the impact at the time of returning to the original position before pressing can be alleviated. Thus, the mechanical noise generated at the time when the key 2a that is released returns to the original position can be suppressed.

By synchronizing the pressing/releasing of the key 2a according to the solenoid 2b and the production of musical sounds according to the MIDI data designated by the user H, it may appear to the user H that the electronic apparatus 1 is played automatically. In the following, driving the solenoid 2b and operating the key 2a based on MIDI data in this way is referred to as “automatic operation of the key 2a”.

It is noted that the MIDI data for outputting musical sounds and for automatically operating the keys 2a may be stored in advance in the electronic piano 1. It may also be that a communication device for communication with an external apparatus is provided in the electronic piano 1 and MIDI data are obtained from an other apparatus or the Internet via the communication device. In addition, the output of musical sounds and the automatic operation of the keys 2a are not limited to being carried out by using the same MIDI data. It may also be that musical sounds are output and the keys 2a are automatically operated by using separate MIDI data.

Although the solenoid 2b is driven during both key-pressing and key-releasing of the key 2a in this way, the embodiment is provided with a maximum control quantity Mc, which is the quantity of the keys 2a that can be pressed and released at the same time, and key-pressing and key-releasing of the keys 2a are controlled, so that a total of a pressed key quantity Np as the quantity of the keys 2a that are pressed and a released key quantity Nr as the quantity of the keys 2a that are released is less than or equal to the maximum control quantity Mc.

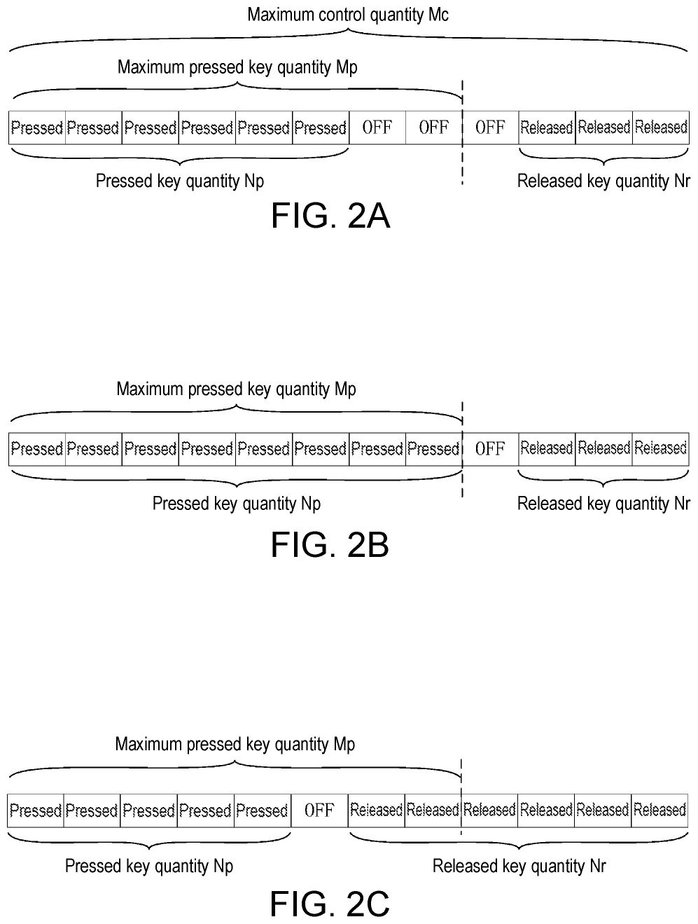

In addition, a maximum pressed key quantity Mp smaller than the maximum control quantity Mc is provided, and pressing of the keys 2a is controlled, so that the pressed key quantity Np is less than or equal to the maximum pressed key quantity Mp. The maximum control quantity Mc and the maximum pressed key quantity Mp are described with reference to FIG. 2A to 2C.

FIG. 2A is a is a diagram illustrating key-pressing and key-releasing states of the keys 2a and the maximum control quantity Mc as well as the maximum pressed key quantity Mp. FIG. 2B is a diagram illustrating the case where the pressed key quantity Np becomes the maximum pressed key quantity Mp. FIG. 2C is a diagram illustrating the case where the pressed key quantity Np is smaller than the maximum pressed key quantity Mp.

As shown in FIG. 2A, in the embodiment, the maximum control quantity Mc, which is the maximum quantity of the keys 2a that can be pressed and released at the same time is set to “12”. The pressing and releasing of the keys 2a are controlled, so that the total of the pressed key quantity Np and the released key quantity Nr is equal to or less than the maximum control quantity Mc. Accordingly, the quantity of the solenoids 2b driven at the same time through key-pressing or key-releasing is limited. Therefore, the increase in power consumption of the electronic piano 1 can be suppressed, and the electronic piano 1 can be operated stably.

In addition, among the maximum control quantity Mc, the maximum pressed key quantity Mp, which is the maximum quantity of the keys 2a that can be pressed, is set to “8”. In other words, by setting the maximum pressed key quantity Mp to be less than the maximum control quantity Mc, even if the pressed key quantity Np reaches the maximum pressed key quantity Mp, it is secured that the quantity of the keys 2a that can be released is at least 4.

For example, as shown in FIG. 2B, in the case where three keys 2a are in key-releasing, and the majority of of the keys 2a receive the key-pressing instruction, the pressing of the keys 2a is controlled, so that the pressed key quantity Np is less than or equal to the maximum pressed key quantity Mp. At this time, in the case where the pressed key quantity Np is greater than the maximum pressed key quantity Mp, a “target pressed key 2a” from the keys 2a during key-pressing is obtained, the target key 2a is instructed to be released, and the key-pressing of a key 2a newly receiving the key-pressing instruction is started. Accordingly, since the total of the pressed key quantity Np and the released key quantity Nr can be less than or equal to the maximum control quantity Mc, the driving (referred to as “key-releasing control” in the following) of the solenoid 2b of the key 2a during key-releasing can continue.

Accordingly, even in the case where the majority of the keys 2a receive the key-pressing instruction, the key-releasing control for the key 2a during key-releasing is continued, and the state in which the velocity of the key 2a during key-releasing is suppressed from the speed based on gravity by the driving force of the solenoid 2b of the key 2a during key-releasing can continue. Thus, the impact at the time of returning to the original position can be suppressed. Accordingly, even in the case where there are multiple keys 2a operated at the same time, the discomfort of the listener with respect to key-releasing can be alleviated.

Meanwhile, the power consumption of the solenoid 2b at the time when the key 2a is released is less than the power consumption at the time when the key 2a is pressed. This is because the driving time of the solenoid 2b is shorter for key-releasing than in key-pressing during the predetermined cycle (i.e., during one millisecond). In the embodiment, it is ensured that keys 2a of the difference (i.e., “4”) between the maximum control quantity Mc and the maximum pressed key quantity Mp among the keys 2a of the maximum pressed keys Mp from the maximum control quantity Mc is only subjected to key-releasing that consumes less power. Accordingly, compared with the case where key-releasing and key-pressing are possible for all the keys 2a of the maximum control quantity Mc, the power consumption required by the keyboard 2 during automatic operation can be reduced, so the electronic piano 1 can be stably operated even with a power source of a smaller capacity. Accordingly, the increase in cost with respect to the power source of the electronic piano 1 can be suppressed.

Moreover, the maximum control quantity Mc is set to 12, and the maximum pressed key quantity Mp is set to 8, respectively. That is, the maximum pressed key quantity Mp is set as a quantity greater than a half of the maximum control quantity Mc. Accordingly, in the case where key-pressing or key-releasing of the keys 2a is performed until the maximum control quantity Mc, the pressed key quantity Np is greater than the released key quantity Nr. Thus, key-pressing of the keys 2a is preferentially performed over key-releasing, so it is possible to prevent the key 2a from being not pressed even when receiving the key-pressing instruction, or from unnecessarily changing the key 2a from key-pressing to key-releasing.

The maximum control quantity Mc and the maximum pressed key quantity Mp are determined by the balance between the capacity of the power source of the electronic piano 1 and the amount of the power consumption of the solenoid 2b. Thus, the maximum control quantity Mc may be set to be equal to or greater than 12 or equal to or less than 12 in accordance with the capacity of the power source or the power consumption of the solenoid 2b. Similarly, the maximum pressed key quantity Mp may be set to be equal to or greater than 8 or equal to or less than 8. The maximum pressed key quantity Mp at this time may still be a quantity less than or equal to the maximum control quantity Mc and greater than or equal to a half of the maximum control quantity Mc.

Here, while the maximum pressed key quantity Mp as the maximum of the quantity of the keys 2a that can be pressed is set, the maximum of the quantity of the keys 2a that can be released is not set. Accordingly, when the pressed key quantity Np is less than the maximum pressed key quantity Mp, the released key quantity Np is configured to be able to exceed the difference (i.e., “4”) between the maximum control quantity Mc and the maximum pressed key quantity Mp. This is because, as described above, the driving time of the solenoid 2b is shorter in key-releasing than in key-pressing. Even if key-releasing is performed in place of key-pressing, the increase in power consumption of the solenoid 2b is small.

For example, in the case where six keys 2a receive the key-pressing instruction at the same time, the key-releasing instruction is given to the same six keys 2a is afterwards, as shown in FIG. 2C. Since it is also possible to perform key-releasing control for the keys 2a greater than the difference between the maximum control quantity Mc and the maximum pressed key quantity Mp in such key-releasing, the situation in which the key-releasing control in some of the keys 2a among the six keys 2a to be released can be avoided. Accordingly, the key-releasing of the keys 2a can be smoothly performed, and the discomfort of the listener with respect to key-releasing can be suppressed.

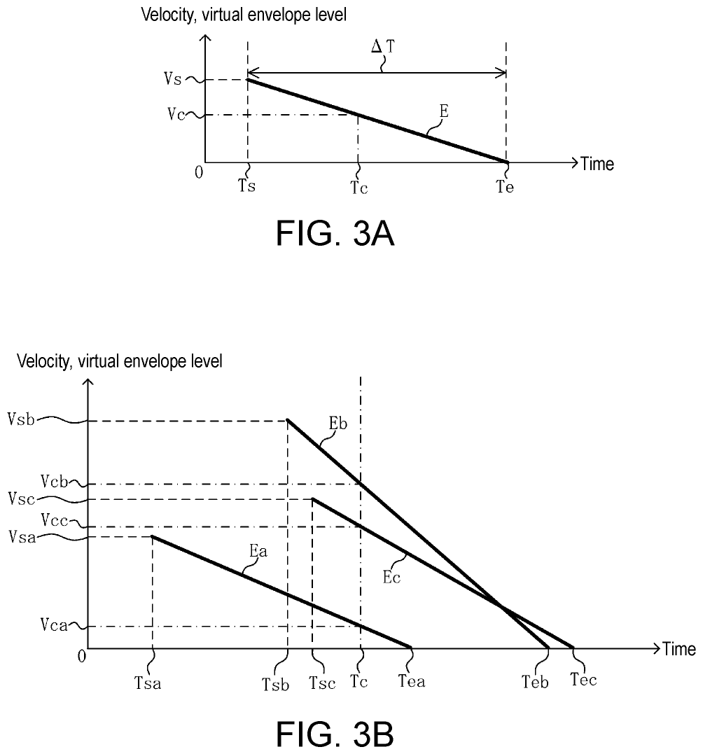

Meanwhile, even when the key-pressing instruction for a new key 2a is given in the state where the pressed key quantity Np is the maximum pressed key quantity Mp, the pressed key quantity Np still needs to be maintained to be equal to or less than the maximum pressed key quantity Mp, and the total of the pressed key quantity Np and the released key quantity Nr still needs to be maintained to be equal to or less than the total control quantity Mc. Therefore, it is necessary to release a key 2a during key-pressing and further stop the release control of the keys 2a during key-releasing. In the embodiment, the target key 2a where the key 2a during key-pressing is to be released or the target key 2a where the key-releasing control is to be stopped is determined based on a virtual envelope according to the velocity at the time of being pressed and the elapsed time from key-pressing. A virtual envelope E is described with reference to FIGS. 3A to 3B.

FIG. 3A is a diagram illustrating the virtual envelope E. In FIGS. 3A and 3B to be described afterwards, the horizontal axis represents time, and the vertical axis represents velocity or the size of the virtual envelope to be described afterwards. The virtual envelope E is a function that represents how the velocity of a musical sound produced according to a key-pressing instruction attenuates over time.

Specifically, the virtual envelope E represents the velocity change in the case of assuming that the velocity of a sound produced at a velocity Vs at a key-pressing start time Ts, which is the time when key-pressing is started, becomes 0 at a time Te after ΔT (e.g., 10 seconds) from the key-pressing start time Ts. In the embodiment, the virtual envelope E is a function obtained by connecting the velocity Vs at the key-pressing start time Ts and the velocity “0” at the time Te by using a line, i.e., linear interpolation.

The velocity at a desired time, such as a velocity Vc at a current time Tc, is obtained from the virtual envelope E and used to determine a target key 2a where key-releasing is to be performed or a target key 2a where key-releasing control is stopped (briefly referred to as “target key 2a”). In the following, the velocity such as Vc obtained from the virtual envelope E is set as “virtual envelope level”. A process of determining the target key 2a using the virtual envelope level is described with reference to FIG. 3B.

FIG. 3B is a diagram illustrating the process of determining the target key 2a using the virtual envelope level. In FIG. 3B, there are three keys 2a pressed or released. Among the keys 2a, the target key 2a is determined at the time Tc. Among the three keys, the key 2a that is firstly pressed is a first key 2al, the key 2a that is secondly pressed is a second key 2a2, and the key 2a that is thirdly pressed is a third key 2a3.

Firstly, a virtual envelope Ea, a virtual envelope Eb, and a virtual envelope Ec respectively corresponding to the first key 2al, the second key 2a2, and the third key 2a3 are respectively calculated. Specifically, the virtual envelope Ea is calculated as a function connecting by using a line a velocity Vsa at a key-pressing start time Tsa of the first key 2a1 and a velocity “0” at a time Tea that is ΔT since the key-pressing start time Tsa.

Similarly, the virtual envelope Eb is calculated as a function connecting by using a line a velocity Vsb at a key-pressing start time Tsb of the second key 2a2 and a velocity “0” at a time Teb that is ΔT since the key-pressing start time Tsb. The virtual envelope Ec is calculated as a function connecting by using a line a velocity Vsc at a key-pressing start time Tsc of the third key 2a3 and a velocity “0” at a time Tec that is ΔT since the key-pressing start time Tsc.

According to the virtual envelopes Ea, Eb, Ec calculated in this way, virtual envelope levels Vca, Vcb, Vcc at the time Tc when the target key 2a is determined are obtained, and the first key 2a1 with the smallest value among the virtual envelope levels Vca, Vcb, Vcc that are obtained is further determined as the target key 2a.

The first key 2a1 determined as the target key 2a in this way has the smallest virtual envelopment level at the time Tc. Therefore, among the first to third keys 2a1 to 2a3 pressed or released at the same time, the first key 2a1 is the key 2a with a small velocity when pressed or the key 2a least related to the sound production state at the time Tc after a period of time has elapsed since the key is pressed.

That is, the first key 2a1 is the least noticeable key 2a in the case where key-pressing is changed to key-releasing among the keys 2a1 to 2a3, and is the key 2a whose mechanical noise is the least noticeable at the time of returning to the original position even if key-releasing control is stopped among the keys 2a1 to 2a3. By setting the hardly noticeable first key 2a1 as “target key 2a” to change from key-pressing to key-releasing or stop key-releasing control, the discomfort of the listener with respect to the change from key-pressing to key-releasing or stopping of key-releasing control can be suppressed.

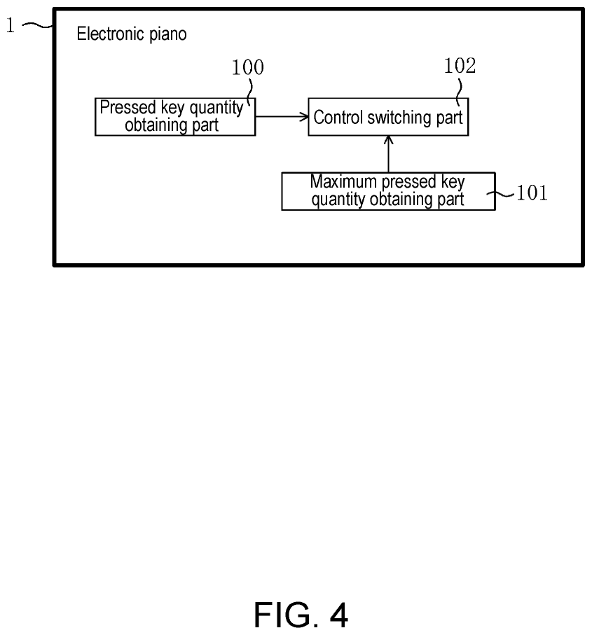

In the following, the function of the electronic piano 1 is described with reference to FIG. 4. FIG. 4 is a functional block diagram of the electronic piano 1. As shown in FIG. 4, the electronic piano 1 has a pressed key quantity obtaining part 100, a maximum pressed key quantity obtaining part 101, and a control switching part 102. The pressed key quantity obtaining part 100 is a part for obtaining the pressed key quantity Np. In addition, the maximum pressed key quantity obtaining part 101 is a part for obtaining the maximum pressed key quantity Mp. The pressed key quantity obtaining part 100 and the maximum pressed key quantity obtaining part 101 are realized by a CPU 10 to be described afterwards with reference to FIG. 5. In the case where an instruction of pressing the key 2a is newly obtained and the pressed key quantity Np obtained by the pressed key quantity obtaining part 100 is equal to or greater than the maximum pressed key quantity Mp obtained by the maximum pressed key quantity obtaining part 101, the control switching part 102 gives a key-releasing instruction to one of the key 2a during key-pressing, and starts key-pressing of the key 2a instructed to be pressed. The control switching part 102 is realized by the CPU 10.

That is, according to the control switching part 102, in the case where the key-pressing instruction for the key 2a is newly obtained and the pressed key quantity Np is equal to or greater than the maximum pressed key quantity Mp, the key-releasing instruction is given to one of the keys 2a during key-pressing, and the key-pressing of the key 2a instructed to be pressed is started. Accordingly, the quantity of the pressed keys 2a can be maintained to be equal to or less than the maximum pressed key quantity Mp before and after the key-pressing instruction is obtained, and it is thus not necessary to stop the key-releasing control of the key 2a during key-releasing due to the key-pressing instruction for the key 2a.

Accordingly, the key-releasing control of the key 2a during key-releasing is continued, and the state in which the speed of the key 2a is suppressed from the speed based on gravity, so the impact at the time of returning to the original position can be suppressed. Accordingly, even in the case where there are multiple keys 2a operated at the same time, the discomfort of the listener with respect to key-releasing can be alleviated. In addition, it is ensured that only key-releasing that consumes less power than key-pressing is performed for the keys 2a in the number of the difference between the maximum control quantity Mc and the maximum pressed key quantity Mp among the keys 2a of the maximum control quantity Mc. Accordingly, compared with the case where key-releasing and key-pressing are possible for all the keys 2a in the maximum control quantity Mc, the power consumption required by the keyboard 2 at the time of automatic operation can be reduced. Thus, the electronic piano 1 can be stably operated even with a power source of a small capacity, and the increase in cost with respect to the power source of the electronic piano 1 can be suppressed.

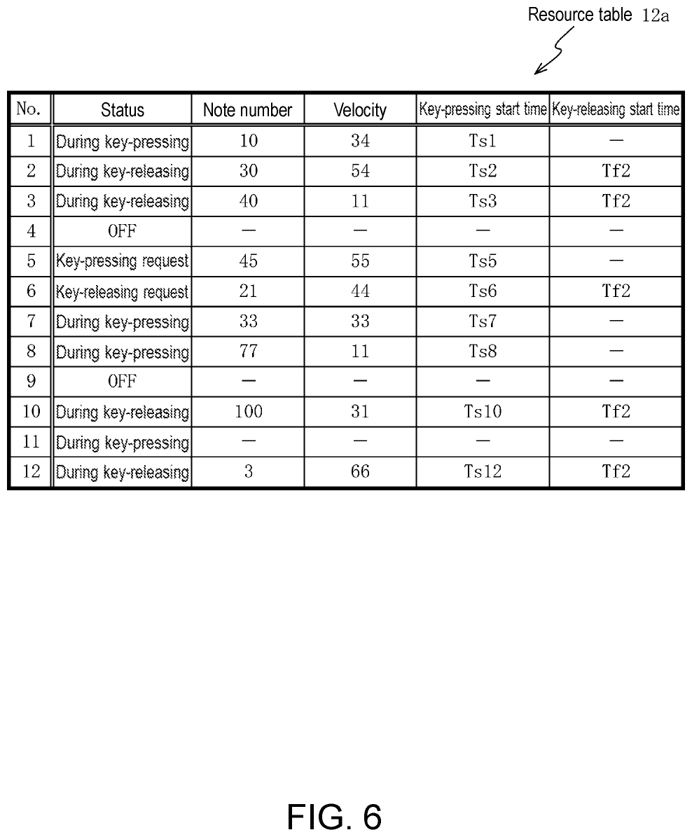

In the following, the electrical configuration of the electronic piano 1 is described with reference to FIGS. 5 and 6. FIG. 5 is a block diagram illustrating the electrical configuration of the electronic piano 1. The electronic piano 1 has the CPU 10, a flash ROM 11, a RAM 12, the keyboard 2, the setting key 3, the LCD 4, a sound source 13, and a digital signal processor 14 (referred to as “DSP 14” in the following). The respective components are connected via a bus line 15.

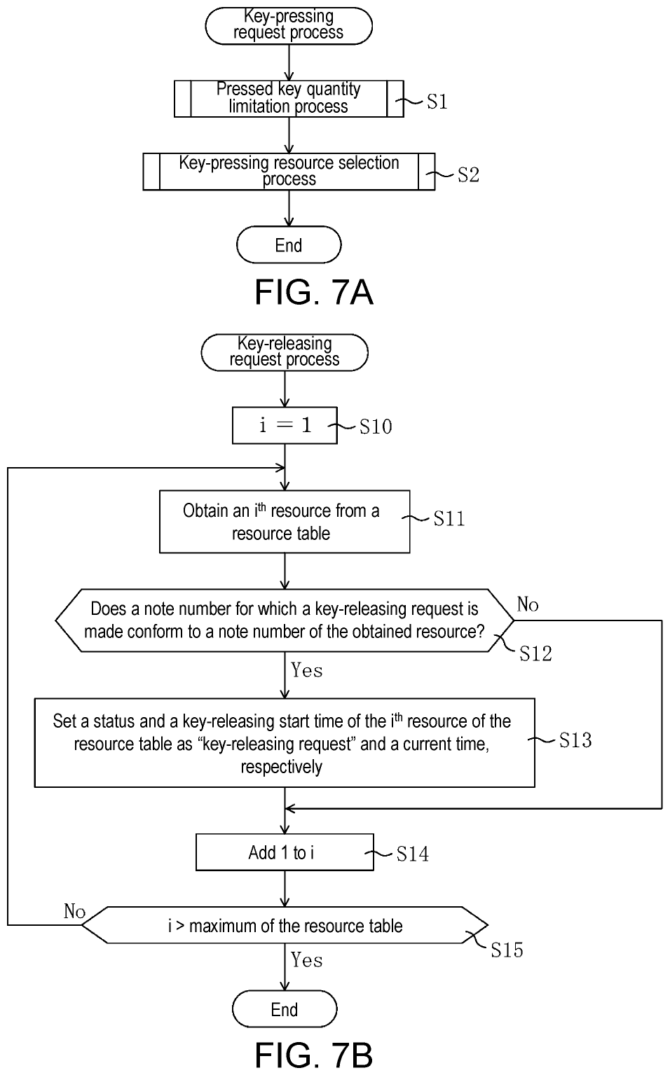

The CPU 10 is a computation device for controlling the respective parts connected by the bus line 15. The flash ROM 11 is a rewritable non-volatile memory device storing programs executed by the CPU 10 and fixed value data, and stores a control program 11a. When the control program 11a is executed by the CPU 10, a key-pressing request process of FIG. 7A and a key-releasing request process of FIG. 7B are executed. The RAM 12 is a memory for rewritably storing various working data, flags, etc., when the CPU 10 executes the programs. In addition, the RAM 12 stores a resource table 12a. The resource table 12a is described herein with reference to FIG. 6.

FIG. 6 is a schematic diagram illustrating the resource table 12a. The resource table 12a is a data table that manages the information of the keys 2a that are pressed or released. As the information of the keys 2a, the resource table 12a is a table where the status, the note number, the velocity, the key-pressing start time, and the key-releasing start time. The status indicates the pressed/released state of the key 2a, the note number of the MIDI corresponds to the key 2a, the velocity is a velocity at the time when the key 2a is pressed, the key-pressing start time is as described with reference to FIGS. 3A and 3B, and the key-releasing start time is the time when key-releasing of the key 2a is started. In the following, the status, the note number, the velocity, the key-pressing start time, and the key-releasing start time of the key 2a stored in the resource table 12a is referred to as “resources of the keys 2a”.

The resource table 12a is configured to be able to store the resources of 12 keys 2a, 12 being the maximum control quantity Mc. As the status stored in the resource table 12a, “key-pressing request” indicating that a key-pressing instruction for the key 2a is received, “during key-pressing”indicating that the key 2a undergoes key-pressing, “key-releasing request” indicating that a key-releasing instruction for the key 2a is received, “during key-releasing” indicating that the key 2a undergoes key-releasing, and “OFF” indicating that the key 2a is neither during key-pressing nor key-releasing are provided.

By using such resource table 12a, key-pressing/key-releasing of the keys 2a is controlled. In particular, in the resource table 12a, the quantity of keys indicating “key-pressing request” or “during key-pressing” is set as the pressed key quantity Np, and the pressing/releasing of the keys 2a is controlled so that the pressed key quantity Np is equal to or less than the maximum pressed key quantity Mp.

Then, the flow returns to FIG. 5. The sound source 13 is a device that outputs waveform data based on the performance information input from the CPU 10. The DSP 14 is an arithmetic device for performing an arithmetic process on waveform data input from the sound source 13. A digital analog converter (DAC) 16 is connected with the DSP 14, an amplifier 17 is connected with the DAC 16, and a speaker 18 is connected with the amplifier 17.

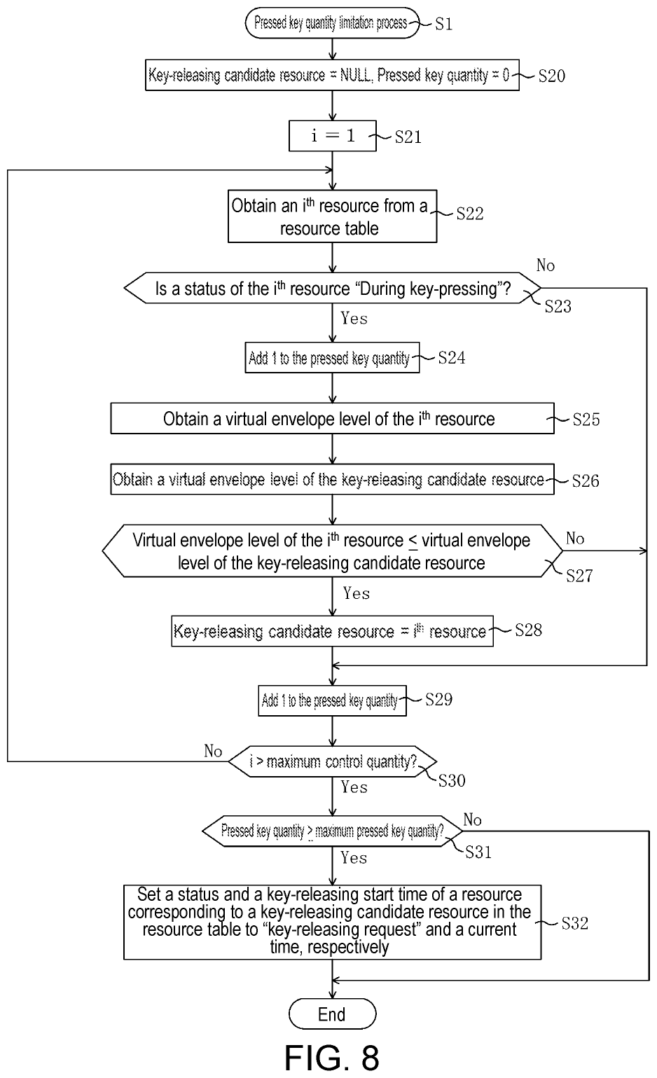

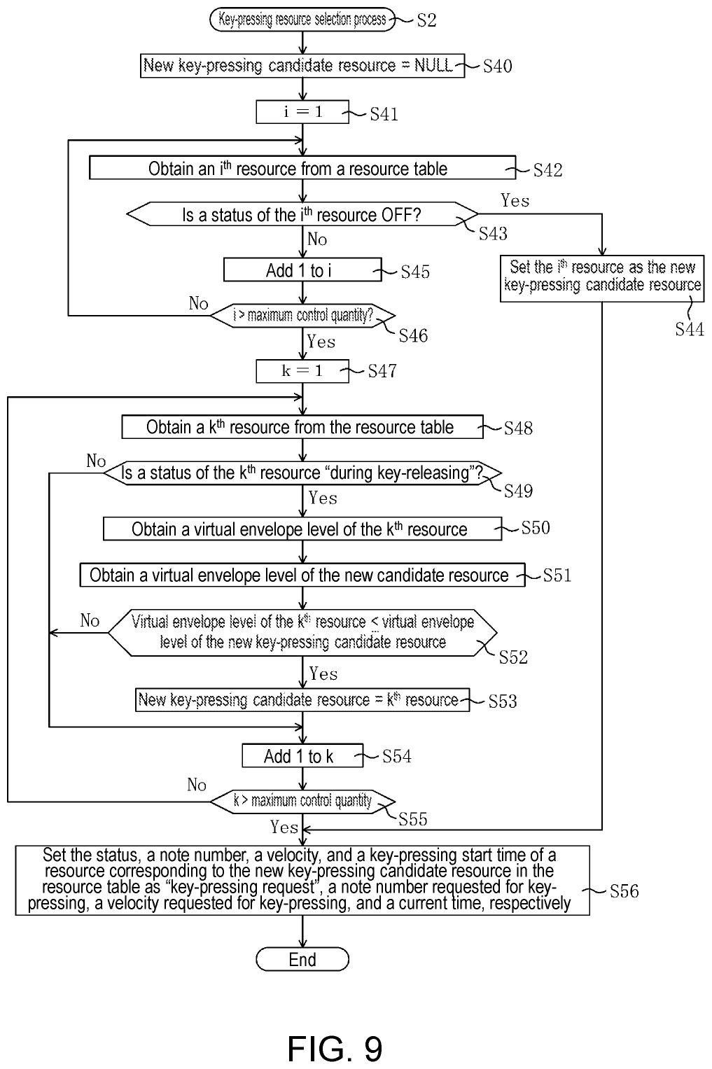

In the following, the processes executed by the CPU 10 of the electronic piano 1 are described with reference to FIGS. 7A to 11. FIG. 7A is a flowchart illustrating a key-pressing request process. The key-pressing request process is a process executed by the CPU 10 in the case where the key-pressing request, which is a key-pressing instruction for the key 2a, is input. In the key-pressing request process, a pressed key quantity limitation process of S1 is performed, and then a pressed key resource selection process of S2 is performed. Here, the pressed key quantity limitation process of S1 and the pressed key resource selection process of S2 are described with reference to FIGS. 8 and 9.

FIG. 8 is a flowchart illustrating the pressed key quantity limitation process. In the pressed key quantity limitation process, firstly, a key-releasing candidate resource in which the resource of the key 2a as a key-releasing candidate is set to NULL, and the pressed key quantity is set to 0 (S20). “NULL” in the embodiment indicates that the resource in a state without setting the status, the node number, the velocity, the key-pressing start time and the key-releasing start time of the key 2a.

After the process of S20, 1 is set to a counter variable i (S21). After the process of S21, an i^{th} resource is obtained from the resource table 12a (S22). After the process of S22, whether the status of the it resource that is obtained indicates “during key-pressing” is verified (S23).

In the case where the status of the i^{th} resource indicates “during key-pressing” (S23: Yes) in the process of S23, 1 is added to the pressed key quantity (S24). After the process of S24, the virtual envelope E is calculated from the key-pressing start time and the velocity of the i^{th} resource, and the virtual envelope level at the current time is obtained from the virtual envelope E that is calculated (S25).

After the process of S25, the virtual envelope E is calculated from the key-pressing start time and the velocity of a key-releasing candidate resource, and the virtual envelope level at the current time is obtained from the calculated virtual envelope E (S26). In the case where the key-releasing candidate resource is NULL, the key-pressing start time and the velocity are not set. Therefore, “255”, which is the maximum value of the virtual envelope level, is obtained as the virtual envelope level.

After the process of S26, whether the virtual envelope level of the i^{th} resource obtained in the process of S25 is equal to or less than the virtual envelope level of the key-releasing candidate resource obtained in the process of S26 is verified (S27). In the case where the virtual envelope level of the i^{th} resource is equal to or less than the virtual envelope level of the key-releasing candidate resource obtained (S27: Yes) in the process of S27, the i^{th} resource is set as the key-releasing candidate resource (S28).

If the status of the i^{th} resource does not indicate “during key-pressing” (S23: No) in the process of S23, if the virtual envelope level of the i^{th} resource is greater than the virtual envelope level of the key-releasing candidate resource in the process of S27 (S27: No) or after the process of S28, 1 is added to the counter variable i (S29).

After the process of S29, whether the counter variable i is greater than the maximum control quantity Mc is verified (S30). In the case where the counter variable i is equal to or less than the maximum control quantity Mc (S30: No) in the process of S30, the processes since S22 are repeated.

In the case where the counter variable i is greater than the maximum control quantity Mc (S30: Yes) in the process of S30, whether the pressed key quantity Np is equal to or greater than the maximum pressed key quantity Mp is verified (S31). The case where the pressed key quantity Np is equal to or greater than the maximum pressed key quantity Mp (S31: Yes) in the process of S31 is the case to release a key 2a corresponding to the key-releasing candidate resource and having the smallest virtual envelope level among the keys 2a during key-pressing. In such case, the status and the key-releasing start time of the resource corresponding to the key-releasing candidate resource in the resource table 12a are set as “key-releasing request” and the current time, respectively (S32).

In the case where the pressed key quantity is smaller than the maximum pressed key quantity Mp (S31: No) in the process of S31 or after the process of S32, the pressed key quantity limitation process is ended.

In the following, the key-pressing resource selection process of S2 is described. FIG. 9 is a flowchart illustrating the key-pressing resource selection process. In the key-pressing resource selection process, firstly, among the resources of the resource table 12a, a new key-pressing candidate resource in which a resource corresponding to the resource setting the resource of a newly pressed key 2a is set as NULL (S40). After the process of S40, 1 is set to the counter variable i (S41). After the process of S41, an i^{th} resource is obtained from the resource table 12a (S42).

After the process of S42, whether the status of the i^{th} resource that is obtained indicates “OFF” is verified (S43). In the case where the status of the i^{th} resource indicates “OFF” (S43: Yes) in the process of S43, the i^{th} resource is vacant, so the i^{th} resource is set as a new key-pressing candidate resource.

Meanwhile, in the case where the status of the i^{th} resource does not indicate “OFF” (S43: No) in the process of S43, 1 is added to the counter variable i (S45), and whether the counter variable i is greater than the maximum control quantity Mc is verified (S46). In the case where the counter variable i is equal to or less than the maximum control quantity Mc (S46: No) in the process of S46, the processes since S42 are repeated.

In the case where the counter variable i is greater than the maximum control quantity Mc (S46: Yes) in the process of S46, 1 is set for a counter variable k. After the process of S41, a k^{th} resource is obtained from the resource table 12a (S48). After the process of S48, whether the status of the k^{th} resource that is obtained indicates “during key-releasing” is verified (S49).

In the case where the status of the k^{th} resource indicates “during key-releasing” (S49: Yes) in the process of S49, the virtual envelope E is calculated from the key-pressing start time and the velocity of the kl resource, and the virtual envelope level at the current time is obtained from the calculated virtual envelope E (S50).

After the process of S50, the virtual envelope E is calculated from the key-pressing start time and the velocity of a new key-releasing candidate resource, and the virtual envelope level at the current time is obtained from the calculated virtual envelope E (S51). It is noted that, in the process of S51 as well, in the case where the new key-pressing candidate resource is NULL, “255” is obtained as the virtual envelope level.

After the process of S51, whether the virtual envelope level of the k^{th} resource obtained in the process of S50 is equal to or less than the virtual envelope level of the new key-pressing candidate resource obtained in the process of S51 is verified (S52). In the case where the virtual envelope level of the k^{th} resource is equal to or less than the virtual envelope level of the new key-pressing candidate resource (S52: Yes) in the process of S52, the kt resource is set as the new key-releasing candidate resource (S53).

If the status of the k^{th} resource does not indicate “during key-releasing” (S49: No) in the process of S49, in the case where the virtual envelope level of the k^{th} resource is greater than the virtual envelope level of the new key-pressing candidate resource in the process of S52 (S52: No) or after the process of S53, 1 is added to the counter variable i (S29). After the process of S54, whether the counter variable k is greater than the maximum control quantity Mc is verified (S55).

In the case where the counter variable k is equal to or less than the maximum control quantity Mc (S55: No) in the process of S55, the processes since S48 are repeated. Meanwhile, in the case where the counter variable k is greater than the maximum control quantity Mc (S55: Yes) in the process of S55 or after the process of S44, in the resource corresponding to the new key-pressing candidate resource in the resource table 12a, the status, the note number, the velocity, and the key-pressing start time are set as “key-pressing request”, the note number corresponding to the key 2a for which a key-pressing request is made, the velocity at the time when key-pressing is requested, and the current time, respectively (S56). Accordingly, in the case where the key 2a corresponding to the new key-pressing candidate resource undergoes key-releasing, the key-releasing control thereof is stopped, and the key-pressing of the key 2a for which a key-pressing request is made is started. After the processes of S56, the key-pressing resource selection process ends.

In the following, key-releasing request process is described with reference to FIG. 7B. FIG. 7B is a flowchart illustrating a key-releasing request process. The key-releasing request process is a process executed by the CPU 10 in the case where the key-releasing request, which is an instruction of releasing the key 2a, is input.

In the key-releasing request process, firstly, 1 is set for the counter variable i (S41). After the process of S10, the i^{th} resource is obtained from the resource table 12a (S11). After the process of S11, whether the note number for which the key-releasing request is made conforms to the note number of the obtained resource is verified (S12). In the case where the note number for which the key-releasing request is made conforms to the note number of the obtained resource (S12: Yes) in the process of S12, the status and the key-releasing start time of the i^{th} resource from the resource table 12a are set as “key-releasing request” and “current time”, respectively.

In the case where the note number for which a key-releasing request is made does not conform to the note number of the obtained resource (S12: No) in the process of S12, or after the process of 513, 1 is added to the counter variable i (S14), and whether the counter variable i is greater than the maximum control quantity Mc is verified (S15). In the case where the counter variable i is equal to or less than the maximum control quantity Mc (S15: No) in the process of S15, the processes since S11 are repeated. Meanwhile, in the case where the counter variable i is greater than the maximum control quantity Mc (S15: Yes) in the process of S15, the key-releasing request process ends.

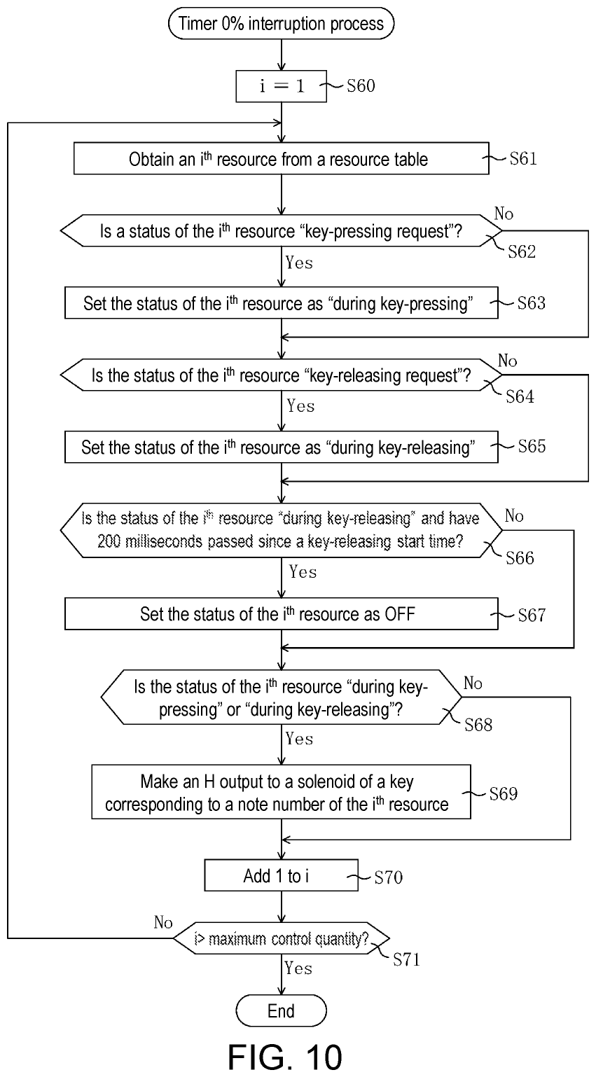

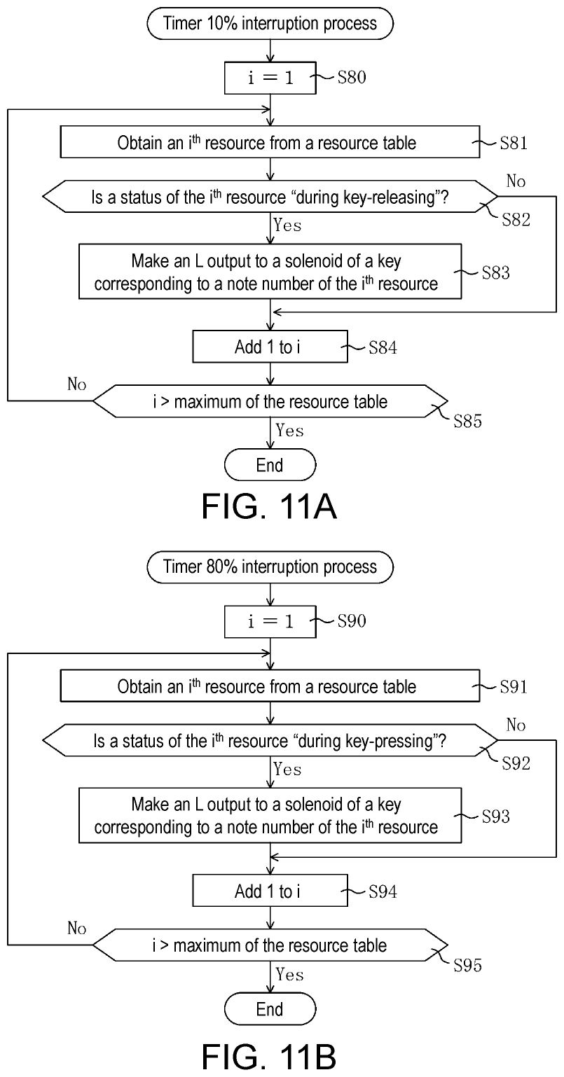

In the following, a timer interruption process is described with reference to FIGS. 10 and 11. In the embodiment, a timer 0% interruption process executed at a start timing of the predetermined cycle (during one millisecond), a timer 10% interruption process executed at a timing after 10% of the cycle has passed since the predetermined cycle starts, and a timer 80% interruption process executed at a timing after 80% of the cycle has passed since the predetermined cycle starts are provided. Firstly, the timer 0% interruption process is described with reference to FIG. 10.

FIG. 10 is a flowchart illustrating the timer 0% interruption process. In the timer 0% interruption process, firstly, 1 is set for the counter variable i (S60). After the process of S60, the i^{th} resource is obtained from the resource table 12a (S61).

After the process of S61, whether the status of the i^{th} resource indicates “key-pressing request” is verified (S62). In the case where the status of the i^{th} resource indicates “key-pressing request” (S62: Yes) in the process of S62, the status of the i^{th} resource from the resource table 12a is set as “during key-pressing” (S63).

In the case where the status of the i^{th} resource does not indicate “key-pressing request” (S62: No) in the process of S62, or after the process of S63, whether the status of the i^{th} resource indicates “key-releasing request” is verified (S64). In the case where the status of the i^{th} resource indicates “key-releasing request” (S64: Yes) in the process of S64, the status of the i^{th} resource from the resource table 12a is set as “during key-releasing” (S65).

In the case where the status of the i^{th} resource does not indicate “key-releasing request” (S64: No) in the process of S64, or after the process of S65, whether the status of the i^{th} resource indicates “during key-releasing” and 200 milliseconds have passed since the key-releasing start time is verified (S66). In the case where the status of the i^{th} resource indicates “during key-releasing” and 200 milliseconds have passed since the key-releasing start time (S66: Yes) in the process of S66, since the timing is the timing at which the key-releasing control of the key 2a corresponding to the i^{th} resource is stopped, the status of the i^{th} resource is set as “OFF” (S67).

In the case where the status of the i^{th} resource does not indicate “during key-releasing” or 200 milliseconds have not passed since the key-releasing start time (S66: No) in the process of S66, or after the process of S67, whether the status of the it resource indicates “during key-pressing” or “during key-releasing” is verified (S68). In the case where the status of the i^{th} resource indicates “during key-pressing” or “during key-releasing” (S68: Yes) in the process of S68, the H output is made to the solenoid 2b of the key 2a corresponding to the note number of the it resource (S69). Accordingly, the driving force of the solenoid 2b for key-pressing control or key-releasing control is applied to the key 2a.

In the case where the status of the i^{th} resource does not indicate “during key-pressing” or “during key-releasing” (S68: No) in the process of S68, or after the process of S69, 1 is added to the counter variable i (S70), and whether the counter variable i is greater than the maximum control quantity Mc is verified (S71). In the case where the counter variable i is equal to or less than the maximum control quantity Mc (S71: No) in the process of S71, the processes since S61 are repeated. Meanwhile, in the case where the counter variable i is greater than the maximum control quantity Mc (S71: Yes) in the process of S71, the timer 0% interruption process ends.

In the following, the timer 10% interruption process is described with reference to FIG. 11A. FIG. 11A is a flowchart illustrating the timer 10% interruption process. In the timer 10% interruption process, firstly, 1 is set for the counter variable i (S80). After the process of S80, the i^{th} resource is obtained from the resource table 12a (S81). After the process of S81, whether the status of the i^{th} resource indicates “during key-releasing” is verified (S82). In the case where the status of the i^{th} resource indicates “during key-releasing” (S82: Yes) in the process of S82, a Low output (L output) is made to the solenoid 2b of the key 2a corresponding to the note number of the i^{th} resource (S83).

That is, the solenoid 2b of the key 2a during key-releasing receives the H output in the process of S69 in the timer 0% interruption process and receives the L output in the process of S83. Accordingly, the driving force of the solenoid 2b of the key 2a during key-releasing is stopped, and the solenoid 2b of the key 2a is driven only during 10% of the predetermined cycle. The driving force of the solenoid 2b is not strong enough to move the key 2a downward but can serve as a resistance force at the time when the key 2a that is released moves upward due to the action of gravity. Accordingly, since the key 2a is released slowly, the mechanical noise due to the impact at the time when the key 2a returns to the original position can be suppressed from occurring.

In the case where the status of the i^{th} resource does not indicate “during key-releasing” (S82: No) in the process of S82, or after the process of S83, 1 is added to the counter variable i (S84), and whether the counter variable i is greater than the maximum control quantity Mc is verified (S85). In the case where the counter variable i is equal to or less than the maximum control quantity Mc (S85: No) in the process of S85, the processes since S81 are repeated. Meanwhile, in the case where the counter variable i is greater than the maximum control quantity Mc (S85: Yes) in the process of S85, the timer 10% interruption process ends.

Lastly, the timer 80% interruption process is described with reference to FIG. 11B. FIG. 11B is a flowchart illustrating the timer 80% interruption process. In the timer 80% interruption process, firstly, 1 is set for the counter variable i (S90). After the process of S90, the i^{th} resource is obtained from the resource table 12a (S91). After the process of S91, whether the status of the i^{th} resource indicates “during key-pressing” is verified (S92). In the case where the status of the i^{th} resource indicates “during key-pressing” (S92: Yes) in the process of S92, the L output is made to the solenoid 2b of the key 2a corresponding to the note number of the i^{th} resource (S93).

That is, the solenoid 2b of the key 2a during key-pressing receives the H output in the process of S69 in the timer 0% interruption process and receives the L output in the process of S93. Accordingly, the driving force of the solenoid 2b of the key 2b during key-pressing is stopped, and the solenoid 2b of the key 2a is driven only during 80% of the predetermined cycle. By limiting the driving of the solenoid 2b during key-pressing of the key 2a to 80% of the predetermined cycle, for example, driving that strikes a balance between power consumption and the key-pressing velocity of the key 2a as compared to driving the solenoid 2b during 100% of the predetermined cycle can be performed.

In the case where the status of the i^{th} resource does not indicate “during key-pressing” (S92: No) in the process of S92, or after the process of S93, 1 is added to the counter variable i (S94), and whether the counter variable i is greater than the maximum control quantity Mc is verified (S95). In the case where the counter variable i is equal to or less than the maximum control quantity Mc (S95: No) in the process of S95, the processes since S91 are repeated. Meanwhile, in the case where the counter variable i is greater than the maximum control quantity Mc (S95: Yes) in the process of S95, the timer 80% interruption process ends.

Although descriptions have been made based on the embodiment, it can be easily inferred that various modifications and changes are possible.

In the embodiment, the virtual envelope E is a function that represents how the velocity Vs produced at the key-pressing start time Ts attenuates. However, the invention is not limited thereto. For example, the virtual envelope E may also correspond to only the elapsed time from the key-pressing start time Ts. In such case, a reciprocal of the elapsed time from the key-pressing start time may also be obtained as a virtual envelope.

In addition, the virtual envelope E undergoes linear interpolation between the velocity Vs at the key-pressing start time Ts and the velocity “0” at the time Te. However, the invention is not limited thereto. For example, the virtual envelope E may also undergo interpolation using a curve such as a quadratic function, a cubic function, an exponential functions, etc., stepped interpolation, or interpolation by using other shapes.

In addition, in the processes of S25 to S28 of FIG. 8 and the processes of S50 to S53 of FIG. 9, the value obtained from the virtual envelope E is used as-is as the virtual envelope level when the key-releasing candidate resource or the new key-pressing candidate resource is determined. However, the invention is not limited thereto. For example, a value obtained by adding or multiplying the value obtained from the virtual envelope E and a coefficient based on the reciprocal of the elapsed time from the key-pressing start time Ts may also serve as the virtual envelope level at the time of choosing the key-releasing candidate resource or the new key-pressing candidate resource.

Accordingly, since the virtual envelope level of the key 2a that has just been pressed can be greater than the virtual envelope level of the key 2a for which time has passed since the key is pressed, it is possible to suppress the key 2a that has just been pressed from being released or to suppress key-releasing control from being stopped. Therefore, the discomfort of the listener can be further suppressed.

In addition, in the processes of S25 to S28 of FIG. 8 and S50 to S53 of FIG. 9, the virtual envelope level is used to select both of the key-releasing candidate resource and the new key-pressing candidate resource. However, the invention is not limited thereto. It may also be that the virtual envelope level is used to select the key-releasing candidate resource only and the new key-pressing candidate resource is selected by other means, and it may also be that the virtual envelope level is used to select the new key-pressing candidate resource only and the key-releasing candidate resource is selected by other means.

In the embodiment, in the case where the key 2a is pressed, the H output is made to the solenoid 2b during 80% of the predetermined cycle. However, the invention is not limited thereto. The H output in the case of key-pressing may also be made during equal to or greater than 80% of the predetermined cycle or during equal to or less than 80%. Similarly, in the case where the key 2a is released, the H output is made to the solenoid 2b during 10% of the predetermined cycle. However, the invention is not limited thereto. The H output in the case of being released may also be made during equal to or greater than 10% of the predetermined cycle or during equal to or less than 10%.

In the embodiment, in the case where the key-pressing request is input, the key-releasing candidate resource is selected from the keys 2a during key-pressing according to the process of S1 of FIG. 8 to perform key-releasing of the key 2a, and the new key-pressing candidate resource is selected from the keys 2a during key-releasing according to the process of S2 of FIG. 9 to stop the key-releasing control of the key 2a. However, the invention is not limited thereto. In the case where the key-pressing instruction is input, it may be that only the process of S1 of FIG. 8 is performed to perform only key-releasing of the key 2a during key-pressing, and it may also be that only the process of S2 of FIG. 9 is performed to stop the key-releasing control on the key 2a during key-releasing.

In the embodiment, although the maximum pressed key quantity Mp is equal to or greater than a half of the maximum control quantity Mc, the invention is not limited thereto. The maximum pressed key quantity Mp may also be equal to or less than a half of the maximum control quantity Mc. In addition, in the embodiment, although the maximum of the keys 2a that can be released has not been set, the invention is not limited thereto. The maximum of the keys 2a that can be released may also be set.

In the embodiment, the output to the solenoid 2b of the key 2a during key-releasing is changed from the H output to the L output at the timing of 10% of the predetermined cycle according to the process of FIG. 11A. However, the invention is not limited thereto. The timing at which the output to the solenoid 2b of the key 2a during key-releasing is changed from the H output to the L output may also be earlier or later than the timing of 10% of the predetermined cycle. Likewise, the output to the solenoid 2b of the key 2a during key-pressing is changed from the H output to the L output at the timing of 80% of the predetermined cycle according to the process of FIG. 11B. However, the invention is not limited thereto. The timing at which the output to the solenoid 2b of the key 2a during key-pressing is changed from the H output to the L output may also be earlier or later than the timing of 80% of the predetermined cycle.

In the embodiment, the electronic piano 1 is described as an electronic instrument. However, the invention is not limited thereto. The invention is also suitable for other electronic instruments, such as synthesizers or electronic wind instruments. In addition, it may also be that the control program 11a can be executed by an information processing device such as personal computers or portable terminals. In such case, the keyboard 2 may also be connected with an information processing device, such as a personal computer.

In the embodiment, MIDI data are described as musical data. However, the invention is not limited thereto. Other music-related data not under the MIDI standard may also be used as musical data.

What is claimed is:

1. An electronic instrument, comprising a keyboard having keys capable of automatic operation, the electronic instrument comprising:
a pressed key quantity obtaining part, obtaining a pressed key quantity that is a quantity of keys pressed in the automatic operation;
a maximum pressed key quantity obtaining part, obtaining a maximum pressed key quantity that is a quantity less than a maximum control quantity, which is a maximum quantity that key-pressing and key-releasing of keys are able to be performed at a same time in the automatic operation, and is a maximum quantity of keys where key-pressing is able to be performed in the automatic operation; and
a control switching part, in a case where a key-pressing instruction for a key is newly obtained in the automatic operation and the pressed key quantity obtained by the pressed key quantity obtaining part is equal to or greater than the maximum pressed key quantity obtained by the maximum pressed key quantity obtaining part, giving a key-releasing instruction to one of keys pressed in the automatic operation and starting key-pressing of the key obtaining the key-pressing instruction.

2. The electronic instrument as claimed in claim 1, comprising a control quantity obtaining part, obtaining a control quantity that is a quantity of keys pressed or released in the automatic operation,
wherein, in a case where the key-pressing instruction for the key is newly obtained in the automatic operation, the control quantity obtained by the control quantity obtaining part is equal to or greater than the maximum control quantity, and the pressed key quantity obtained by the pressed key quantity obtaining part is equal to or greater than the maximum pressed key quantity obtained by the maximum pressed key quantity obtaining part, the control switching part gives a key-releasing control stop instruction to one of keys released in the automatic operation, gives the key-releasing instruction to one of the keys pressed in the automatic operation, and starts key-pressing of the key obtaining the key-pressing instruction.

3. The electronic instrument as claimed in claim 1, comprising a control quantity obtaining part, obtaining a control quantity that is a quantity of keys pressed or released in the automatic operation,
wherein, in a case where the key-pressing instruction for the key is newly obtained in the automatic operation, the control quantity obtained by the control quantity obtaining part is equal to or greater than the maximum control quantity, and the pressed key quantity obtained by the pressed key quantity obtaining part is less than the maximum pressed key quantity obtained by the maximum pressed key quantity obtaining part, the control switching part gives a key-releasing control stop instruction to one of keys released in the automatic operation, and starts key-pressing of the key obtaining the key-pressing instruction.

4. The electronic instrument as claimed in claim 1, comprising an envelope calculation part, in a case of obtaining the key-pressing instruction of the key in the automatic operation, calculating a virtual envelope of a musical sound based on the key-pressing instruction,
wherein the control switching part obtains a virtual envelope level at such time point from the virtual envelope calculated by the envelope calculation part for each key pressed in the automatic operation and gives the key-releasing instruction to a key whose virtual envelope level that is obtained is minimum.

5. The electronic instrument as claimed in claim 2, comprising an envelope calculation part, in a case of obtaining the key-pressing instruction of the key in the automatic operation, calculating a virtual envelope of a musical sound based on the key-pressing instruction,
wherein the control switching part obtains a virtual envelope level at such time point from the virtual envelope calculated by the envelope calculation part for each key released in the automatic operation and gives the key-releasing control stop instruction to a key whose virtual envelope level that is obtained is minimum.

6. The electronic instrument as claimed in claim 4, wherein the envelope calculation part calculates the virtual envelope based on a time and a velocity at a key-pressing time of the key and an elapsed time from the key-pressing.

7. The electronic instrument as claimed in claim 5, wherein the envelope calculation part calculates the virtual envelope based on a time and a velocity at a key-pressing time of the key and an elapsed time from the key-pressing.

8. The electronic instrument as claimed in claim 6, wherein the envelope calculation part calculates, as the virtual envelope, a virtual envelope linearly interpolated in a case where the velocity at the key-pressing time of the key is set as a velocity in the key-pressing instruction thereof and a velocity after a predetermined time from the time is set as 0.

9. The electronic instrument as claimed in claim 7, wherein the envelope calculation part calculates, as the virtual envelope, a virtual envelope linearly interpolated in a case where the velocity at the key-pressing time of the key is set as a velocity in the key-pressing instruction thereof and a velocity after a predetermined time from the time is set as 0.

10. The electronic apparatus as claimed in claim 1, wherein the maximum pressed key quantity is a quantity greater than a half of the maximum control quantity.

11. An automatic operation method executed by an electronic instrument comprising a keyboard having keys capable of automatic operation, the automatic operation method comprising:
a pressed key quantity obtaining step of obtaining a pressed key quantity that is a quantity of keys pressed at a same time in the automatic operation;
a maximum pressed key quantity obtaining step, obtaining a maximum pressed key quantity that is a quantity less than a maximum control quantity, which is a maximum quantity key-pressing and key-releasing of keys are able to be performed at a same time in the automatic operation, and is a maximum quantity of keys where key-pressing is able to be performed in the automatic operation; and
a control switching step, in a case where a key-pressing instruction for a key is newly obtained in the automatic operation and the pressed key quantity obtained in the pressed key quantity obtaining step is equal to or greater than the maximum pressed key quantity obtained in the maximum pressed key quantity obtaining step, giving a key-releasing instruction to one of keys pressed in the automatic operation and starting key-pressing of the key obtaining the key-pressing instruction.

12. A non-transitory computer readable medium, storing an automatic operation program, the automatic operation program causing a computer comprising a keyboard having keys capable of automatic operation to execute an automatic operation process for the keys of the keyboard, the automatic operation program comprising:
a pressed key quantity obtaining step of obtaining a pressed key quantity that is a quantity of keys pressed at a same time in the automatic operation;
a maximum pressed key quantity obtaining step, obtaining a maximum pressed key quantity that is a quantity less than a maximum control quantity, which is a maximum quantity key-pressing and key-releasing of keys are able to be performed at a same time in the automatic operation, and is a maximum quantity of keys where key-pressing is able to be performed in the automatic operation; and
a control switching step, in a case where a key-pressing instruction for a key is newly obtained in the automatic operation and the pressed key quantity obtained in the pressed key quantity obtaining step is equal to or greater than the maximum pressed key quantity obtained in the maximum pressed key quantity obtaining step, giving a key-releasing instruction to one of keys pressed in the automatic operation and starting key-pressing of the key obtaining the key-pressing instruction.

13. The electronic instrument as claimed in claim 2, comprising an envelope calculation part, in a case of obtaining the key-pressing instruction of the key in the automatic operation, calculating a virtual envelope of a musical sound based on the key-pressing instruction,
wherein the control switching part obtains a virtual envelope level at such time point from the virtual envelope calculated by the envelope calculation part for each key pressed in the automatic operation and gives the key-releasing instruction to a key whose virtual envelope level that is obtained is minimum.

14. The electronic instrument as claimed in claim 3, comprising an envelope calculation part, in a case of obtaining the key-pressing instruction of the key in the automatic operation, calculating a virtual envelope of a musical sound based on the key-pressing instruction,
wherein the control switching part obtains a virtual envelope level at such time point from the virtual envelope calculated by the envelope calculation part for each key released in the automatic operation and gives the key-releasing control stop instruction to a key whose virtual envelope level that is obtained is minimum.

15. The electronic instrument as claimed in claim 13, wherein the envelope calculation part calculates the virtual envelope based on a time and a velocity at a key-pressing time of the key and an elapsed time from the key-pressing.

16. The electronic instrument as claimed in claim 14, wherein the envelope calculation part calculates the virtual envelope based on a time and a velocity at a key-pressing time of the key and an elapsed time from the key-pressing.

17. The electronic instrument as claimed in claim 15, wherein the envelope calculation part calculates, as the virtual envelope, a virtual envelope linearly interpolated in a case where the velocity at the key-pressing time of the key is set as a velocity in the key-pressing instruction thereof and a velocity after a predetermined time from the time is set as 0.

18. The electronic instrument as claimed in claim 16, wherein the envelope calculation part calculates, as the virtual envelope, a virtual envelope linearly interpolated in a case where the velocity at the key-pressing time of the key is set as a velocity in the key-pressing instruction thereof and a velocity after a predetermined time from the time is set as 0.
